(19) United States
(12) Patent Application Publication
(10) Pub. No.: US 2025/0173548 A1
(43) Pub. Date: May 29, 2025

(54) INFORMATION PROCESSING DEVICE AND INFORMATION PROCESSING METHOD

(71) Applicant: Panasonic Automotive Systems Co., Ltd., Kanagawa (JP)

(72) Inventors: Yutaka YOSHIHAMA, Osaka (JP); Kenichi YADANI, Kyoto (JP)

(73) Assignee: Panasonic Automotive Systems Co., Ltd., Kanagawa (JP)

(21) Appl. No.: 18/954,125

(22) Filed: Nov. 20, 2024

(30) Foreign Application Priority Data
Nov. 29, 2023 (JP) 2023-202225

(51) Int. Cl. G06N 3/045; G06N 3/082

(52) U.S. Cl. CPC G06N 3/045; G06N 3/082

(57) ABSTRACT

An information processing device includes an input acquirer which acquires a first model of deep learning and a transform unit which selects a fully connected layer included in the first model, transforms the selected fully connected layer into a convolution layer, and deletes a dimensional transformation layer and a dimensional inverse transformation layer that are included in the first model. The dimensional transformation layer transforms the total number of dimensions of input information from three to two, and outputs the input information represented in two dimensions to the fully connected layer. The dimensional inverse transformation layer inversely transforms the number of dimensions of output information output from the fully connected layer from two to three.

### CROSS REFERENCE TO RELATED APPLICATION

The present application is based on and claims priority of Japanese Patent Application No. 2023-202225 filed on Nov. 29, 2023.

### FIELD

The present disclosure relates to an information processing device and the like which perform processing related to machine learning.

### BACKGROUND

In recent years, Transformers have been proposed (see, for example, Non Patent Literature 1). The Transformer is a deep learning model, and is a network architecture which connects an encoder and a decoder using only an Attention. The Transformer is utilized in ChatGPT (registered trademark).

### CITATION LIST

### Patent Literature

PTL 1: A. Vaswani, N. Shazeer, N. Parmar, J. Uszkoreit, L. Jones, A. N. Gomez, L. Kaiser, and I. Polosukhin, “Attention Is All You Need”, NIPS 2017, pp. 5998-6008 (2017)

### SUMMARY

However, processing using a deep learning model such as the Transformer described in NPL 1 can be improved upon.

Hence, the present disclosure provides an information processing device and the like capable of improving upon the above related art.

An information processing device according to an aspect of the present disclosure includes: a processor; and a memory that is connected to the processor, using the memory, the processor: acquires a first model of deep learning; selects a fully connected layer included in the first model; transforms the fully connected layer selected into a convolution layer; and deletes a dimensional transformation layer and a dimensional inverse transformation layer that are included in the first model, the dimensional transformation layer: transforms a total number of dimensions of input information from three to two; and outputs the input information represented in two dimensions to the fully connected layer, and the dimensional inverse transformation layer inversely transforms a total number of dimensions of output information output from the fully connected layer from two to three.

These general or specific aspects may be realized by a system, a method, an integrated circuit, a computer program, or a computer-readable recording medium such as a CD-ROM, or may be realized by any combination of a system, a method, an integrated circuit, a computer program, and a recording medium. The recording medium may be a non-transitory recording medium.

The information processing device of the present disclosure can be improved upon.

Further advantages and effects of the aspect of the present disclosure will become apparent from the specification and drawings. Such advantages and/or effects are provided by configurations described in some the embodiments, specification, and the drawings, but not all of the configurations are necessarily required.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a block diagram showing an example of the configuration of an information processing device in an embodiment.

FIG. 2 is a diagram for illustrating a processing operation in which the information processing device in the embodiment handles a first model and a second model in comparison with a processing operation in a device in a comparative example.

FIG. 3 is a diagram for illustrating transformation of the number of dimensions in the embodiment.

FIG. 4 is a diagram for illustrating the processing operation of a fully connected layer in the embodiment.

FIG. 5 is a diagram for illustrating the processing operation of a convolution layer in the embodiment.

FIG. 6 is a diagram for illustrating the processing operation of the convolution layer when the size of a kernel is 1×1 in the embodiment.

FIG. 7 is a flowchart showing an example of the processing operation of the information processing device in the embodiment.

FIG. 8 is a block diagram showing an example of the configuration of an information processing device in a variation of the embodiment.

FIG. 9 is a diagram for illustrating the processing of a parameter duplicator in the variation of the embodiment.

### DESCRIPTION OF EMBODIMENT

### (Underlying Knowledge Forming Basis of the Present Disclosure)

The present inventor has found that the following problem occurs on the Transformer in NPL 1 described in the “Technical Field”.

The Transformer is applied to a variety of tasks as it is applied to ChatGPT. The Transformer is rated faster and more accurate than a long short-term memory (LSTM) network.

On the other hand, a deep learning model such as the Transformer includes a fully connected layer and another layer, and the number of dimensions of input information which is handled may be different between the fully connected layer and the other layer. Hence, in the deep learning model as described above, the number of dimensions of the input information is transformed and inversely transformed. When the number of dimensions is transformed and inversely transformed, the speed of processing using the model is decreased. As the number of times the dimensional transformation and the dimensional inverse transformation are performed is increased, the speed of the processing is decreased. For example, the Transformer includes a multi-head attention layer, a masked multi-head attention layer, and a feed forward layer. Each of the layers further includes a fully connected layer and a dimensional transformation layer and a dimensional inverse transformation layer for transforming and inversely transforming the number of dimensions as described above. Hence, a larger number of sets of the fully connected layer, the dimensional transformation layer, and the dimensional inverse transformation layer are included in the Transformer. Consequently, there is a problem in that processing using the Transformer is faster than the LSTM network but is slower than a convolutional neural network (CNN). When the Transformer is incorporated into, for example, an edge device such as a smartphone, its processing is remarkably slow.

In order to solve the problem as described above, an information processing device according to a first aspect of the present disclosure includes: a processor; and a memory that is connected to the processor, using the memory, the processor: acquires a first model of deep learning; selects a fully connected layer included in the first model; transforms the fully connected layer selected into a convolution layer; and deletes a dimensional transformation layer and a dimensional inverse transformation layer that are included in the first model, the dimensional transformation layer: transforms a total number of dimensions of input information from three to two; and outputs the input information represented in two dimensions to the fully connected layer, and the dimensional inverse transformation layer inversely transforms a total number of dimensions of output information output from the fully connected layer from two to three.

In this way, the fully connected layer which performs processing (that is, two-dimensional processing) on the input information represented in two dimensions is transformed into the convolution layer which performs processing (that is, three-dimensional processing) on the input information represented in three dimensions. Furthermore, the dimensional transformation layer and the dimensional inverse transformation layer necessary for the three-dimensional processing in the fully connected layer are deleted from the first model. By the transformation into the convolution layer and the deletion of the dimensional transformation layer and the dimensional inverse transformation layer as described above, a second model equivalent to the first model can be generated. Then, the number of layers included in the second model is less than the number of layers included in the first model, and thus the speed of processing using the second model can be increased. Consequently, it is possible to generate a deep learning model capable of high-speed processing without deterioration of accuracy. The processing described above is also said to be inference. Hence, it is possible to generate a deep learning model capable of high-speed inference processing without deterioration of inference accuracy.

Specifically, although the processing using a deep learning model such as the Transformer described in NPL 1 has a problem that it is slow, the present disclosure can provide a deep learning model capable of high-speed processing without deterioration of accuracy.

In an information processing device according to a second aspect, the processor may further perform machine learning on the second model that is generated by transforming the fully connected layer into the convolution layer and deleting the dimensional transformation layer and the dimensional inverse transformation layer. The second aspect may depend on the first aspect.

In this way, it is possible to obtain an inference result corresponding to the machine learning. It is also possible to rapidly obtain an inference result equivalent to an inference result caused by a machine-trained first model.

In an information processing device according to a third aspect, the processor may further duplicate a parameter for the first model on which machine learning has already been performed, and inserts the parameter duplicated into the second model that is generated by transforming the fully connected layer into the convolution layer and deleting the dimensional transformation layer and the dimensional inverse transformation layer. The third aspect may depend on the first aspect or the second aspect.

In this way, it is possible to generate a model equivalent to the machine-trained second model without performing machine learning on the second model, with the result that it is possible to increase the efficiency of generation of a model.

In an information processing device according to a fourth aspect, the input information represented in three dimensions may include a plurality of input values arranged along a first axis, a second axis, and a channel axis, the input information represented in two dimensions may include a plurality of input values arranged along the second axis and the channel axis, the fully connected layer may include, for each of channels on the channel axis, a weighting coefficient to be applied to the input information represented in two dimensions, the convolution layer may include, for each of the channels on the channel axis, a kernel to be applied to the input information represented in three dimensions, the size of the kernel for each of the channels may be 1×1, and in the input information represented in three dimensions that is input to the convolution layer, the total number of input values disposed along the first axis may be one. The fourth aspect may depend on any one of the first to third aspects. The first axis, the second axis, and the channel axis are also referred to as an i axis, a j axis, and a Ci axis.

In this way, it is possible to appropriately generate a deep learning model capable of high-speed processing without deterioration of accuracy.

### Embodiment

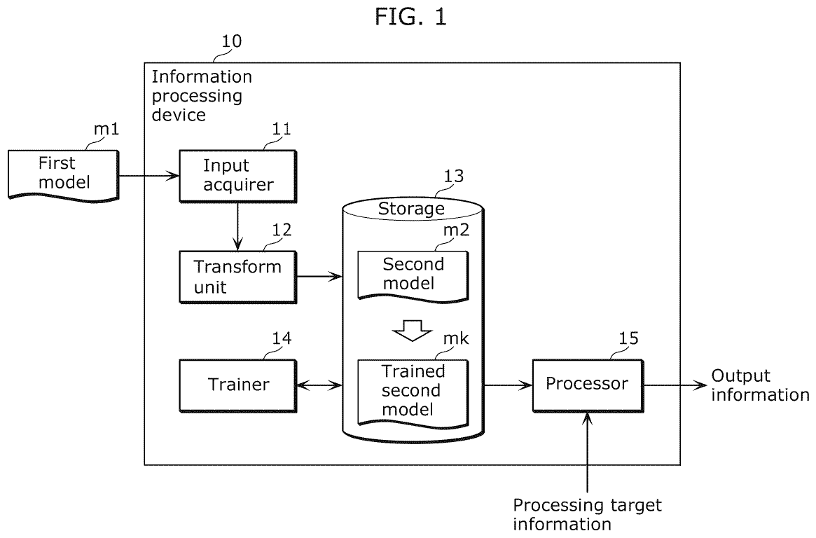

FIG. 1 is a block diagram showing an example of the configuration of an information processing device in the present embodiment.

Information processing device 10 in the present embodiment includes input acquirer 11, transform unit 12, storage 13, trainer 14, and processor 15.

Input acquirer 11 acquires first model m1 which is a deep learning model. Then, input acquirer 11 outputs first model m1 to transform unit 12. First model m1 may be a Transformer or another model. First model m1 may be a model in which machine learning has not been performed or may be a model in which machine learning has already been performed.

When transform unit 12 acquires first model m1 from input acquirer 11, transform unit 12 transforms first model m1 into second model m2, and stores second model m2 in storage 13.

Storage 13 is a recording medium for storing second model m2 and trained second model mk which will be described later. For example, storage 13 is a hard disk drive, a random access memory (RAM), a read only memory (ROM), a semiconductor memory, or the like. Storage 13 as described above may be volatile or nonvolatile.

Trainer 14 performs machine learning on second model m2 stored in storage 13 to generate trained second model mk. Trained second model mk as described above is stored in storage 13.

Processor 15 acquires processing target information, inputs the processing target information to trained second model mk stored in storage 13, and thereby acquires output information output from trained second model mk. Then, processor 15 outputs the output information to the outside of information processing device 10. When processing which is performed by trained second model mk on the processing target information is inference, the output information is an inference result for the processing target information.

A unit which includes input acquirer 11, transform unit 12, trainer 14, and processor 15 may be formed as one or more processors such as central processing units (CPU). For example, a program stored in a memory may be executed by a processor such that the unit is realized. The memory may be storage 13. In other words, information processing device 10 in the present embodiment may include a processor and a memory connected to the processor. In this case, the processor uses the memory to perform processing in at least one of input acquirer 11, transform unit 12, trainer 14, and processor 15.

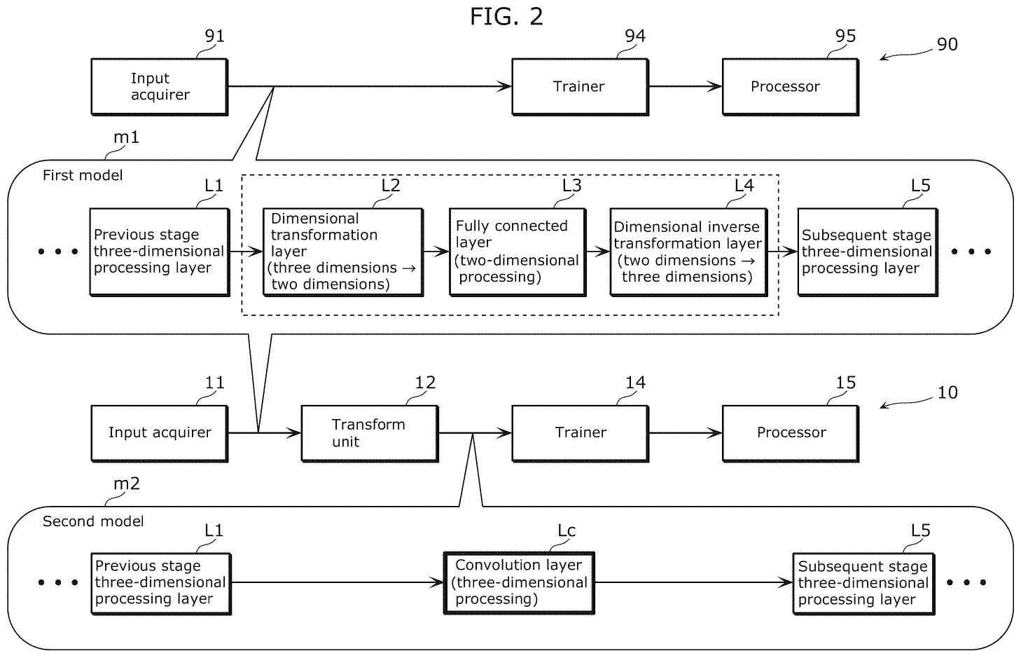

FIG. 2 is a diagram for illustrating a processing operation in which information processing device 10 in the present embodiment handles first model m1 and second model m2 in comparison with a processing operation in a device in a comparative example.

Device 90 in the comparative example includes input acquirer 91, trainer 94, and processor 95. When input acquirer 91 acquires first model m1, input acquirer 91 outputs first model m1 to trainer 94. Trainer 94 performs machine learning on first model m1 to generate a machine-trained first model. Processor 95 inputs processing target information to the machine-trained first model to acquire output information output from the machine-trained first model.

Here, in device 90 in the comparative example, machine learning is performed on first model m1. As shown in FIG. 2, first model m1 includes previous stage three-dimensional processing layer L1, dimensional transformation layer L2, fully connected layer L3, dimensional inverse transformation layer L4, and subsequent stage three-dimensional processing layer L5. Previous stage three-dimensional processing layer L1 performs, on input information represented in three dimensions, processing is, three-dimensional (that processing) corresponding to the number of dimensions thereof, and thereby outputs output information represented in three dimensions. For example, previous stage three-dimensional processing layer L1 is a layer included in the Transformer, and corresponds to batch normalization for normalizing a matrix or the like. Dimensional transformation layer L2 handles the output information represented in three dimensions as input information, transforms it into output information represented in two dimensions, and outputs the output information represented in two dimensions. Fully connected layer L3 handles the output information represented in two dimensions as input information, performs processing (that is, two-dimensional processing) corresponding to the number of dimensions thereof on the input information, and thereby outputs output information represented in two dimensions. Dimensional inverse transformation layer L4 handles the output information represented in two dimensions as input information, transforms it into output information represented in three dimensions, and outputs the output information represented in three dimensions. Subsequent stage three-dimensional processing layer L5 handles the output information represented in three dimensions as input information, performs processing (that is, three-dimensional processing) corresponding to the number of dimensions thereof on the input information, and thereby outputs output information represented in three dimensions. For example, subsequent stage three-dimensional processing layer L5 is a layer included in the Transformer, and corresponds to MatMul (that is, Matrix Multiplication) for computing a matrix product or the like.

On the other hand, in information processing device 10 in the present embodiment, first model m1 acquired by input acquirer 11 is transformed by transform unit 12 into second model m2. Then, in trainer 14, machine learning is performed on second model m2. Transform unit 12 transforms fully connected layer L3 included in first model m1 into convolution layer Lc, and deletes dimensional transformation layer L2 and dimensional inverse transformation layer L4 before and after fully connected layer L3. In this way, first model m1 is transformed into second model m2. Convolution layer Lc of second model m2 handles, as input information, output information output from previous stage three-dimensional processing layer L1 and represented in three dimensions, performs processing (that is, three-dimensional processing) corresponding to the number of dimensions thereof on the input information, and thereby outputs output information represented in three dimensions. In other words, in second model m2, fully connected layer L3 for performing two-dimensional processing is replaced with convolution layer Lc for performing three-dimensional processing, and thus it is possible to omit dimensional transformation layer L2 and dimensional inverse transformation layer L4 which transform the number of dimensions of input information or output information.

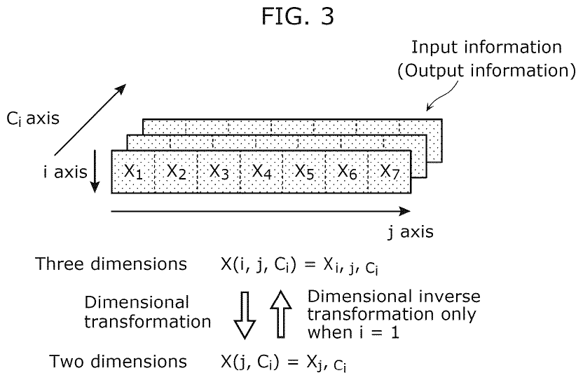

FIG. 3 is a diagram for illustrating transformation of the number of dimensions.

Input information includes a plurality of input values X which are arranged along an i axis, a j axis, and a Ci axis. That is, the input information is said to be represented in three dimensions of the i axis, the j axis, and the Ci axis. In other words, each of the plurality of input values X is represented in three dimensions as X (i, j, Ci), X_{i, j, ci} or the like. The output information has the same configuration as the input information. The Ci axis is also referred to as a channel axis, and a plurality of input values X are arranged along the i axis and the j axis for each of channels Ci on the channel axis. Previous stage three-dimensional processing layer L1 and subsequent stage three-dimensional processing layer L5 perform three-dimensional processing on the input information represented in three dimensions as described above.

Here, when the number of input values X disposed along the i axis is only one, that is, when i=1, the input information represented in three dimensions of the i axis, the j axis, and the Ci axis can be transformed into input information represented in two dimensions of the j axis, and the Ci axis. In other words, the input information, to be more specific, each of a plurality of input values X included in the input information is represented in two dimensions as X (j, Ci), X_{j, ci} or the like. Conversely, the input information represented in two dimensions of the j axis and the Ci axis can be transformed into the input information represented in three dimensions of the i axis, the j axis, and the Ci axis. Dimensional transformation layer L2 and dimensional inverse transformation layer L4 transform the number of dimensions of the input information as described above. Specifically, dimensional transformation layer L2 transforms the number of dimensions from three to two, and dimensional inverse transformation layer L4 transforms the number of dimensions from two to three.

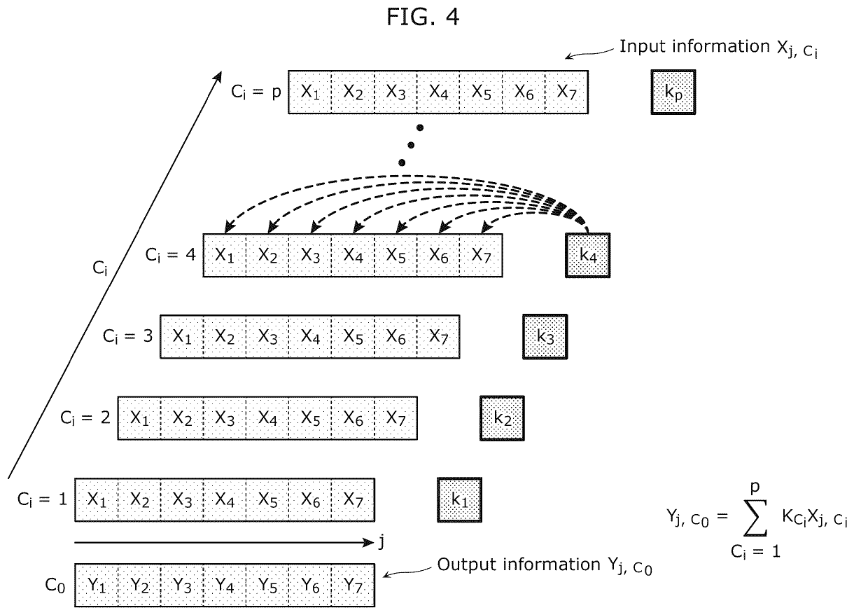

FIG. 4 is a diagram for illustrating the processing operation of fully connected layer L3.

Fully connected layer L3 includes, for each of the channels Ci, a weighting coefficient Kai corresponding to the channel Ci. Fully connected layer L3 uses the weighting coefficients K_{ci} to perform two-dimensional processing on input information represented in two dimensions. The input information is also said to indicate a vector or a feature amount for each of the channels Ci.

Specifically, fully connected layer L3 multiplies input values X_{j, ci} in positions j on the j axis included in each of a plurality of channels Ci by the weighting coefficient K_{ci} for the channel Ci corresponding to the input values X_{j, ci}, and sums the resulting values, and thereby outputs an output value Y_{j, c0} in positions j. In other words, output information including the output value Y_{j, c0} is output. More specifically, fully connected layer L3 performs a computation corresponding to formula (1) below to output the output information. In formula (1) below, p is an integer of 1 or more and indicates the number of channels, and Ci can be an integer from 1 to p.

$$\begin{matrix}[ Math . 1 ] & \\ {Y}_{j , C 0} = {\sum }_{Ci = 1}^{p} {K}_{Ci} {X}_{j , Ci} & formula ( 1 )\end{matrix}$$

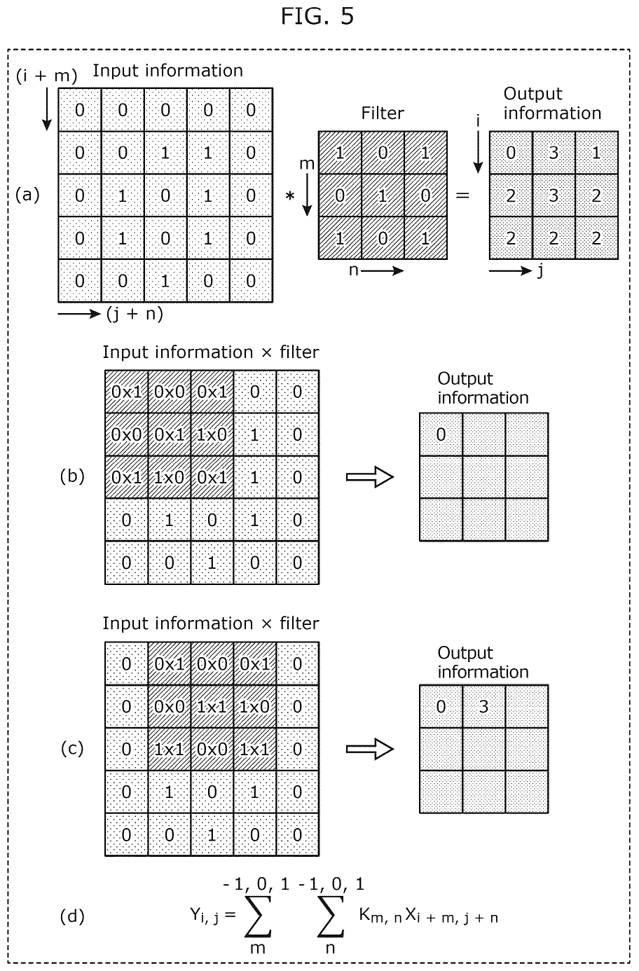

FIG. 5 is a diagram for illustrating the processing operation of convolution layer Lc. FIG. 5 shows the processing operation performed by convolution layer Lc on one channel Ci.

As shown in part (a) in FIG. 5, convolution layer Lc applies a filter to input information corresponding to the channel Ci to output output information corresponding to the channel Ci. Here, convolution layer Lc outputs the output information while changing the position on the coordinate space of the input information to which the filter is applied. The input information and the output information corresponding to the channel Ci are, for example, an image. In the example of part (a) in FIG. 5, the input information is formed by the arrangement of 5×5 input values, and the output information is formed by the arrangement of 3×3 output values. The filter is formed by the arrangement of 3×3 filter coefficients, and is also referred to as a kernel.

In a specific example, as shown in part (b) in FIG. 5, nine filter coefficients K_{m, n} present in nine positions indicated by m=−1, 0, 1 and n=−1, 0, 1 are applied to nine input values X_{i+m, j+n} present in nine positions indicated by (i+m)=0, 1, 2 and (j+n)=0, 1, 2 in the input information. In the example shown in FIG. 5, i and j each can be an integer from 1 to 3. In other words, the input values X_{i+m, j+n} are multiplied by the filter coefficients K_{m, n}. Consequently, an output value Y_{1, 1} in a position indicated by i=1 and j=1 is output. In the example shown in FIG. 5, Y_{1, 1}=0 is calculated.

Then, the position of the filter is changed in the direction of the j axis. Consequently, for example, as shown in part (c) in FIG. 5, nine filter coefficients K_{m, n} present in nine positions indicated by m=−1, 0, 1 and n=−1, 0, 1 are applied to nine input values X_{i+m, j+n} present in nine positions indicated by (i+m)=0, 1, 2 and (j+n)=1, 2, 3. In other words, the input values X_{i+m, j+n} are multiplied by the filter coefficients K_{m, n}. Consequently, an output value Y_{1, 2} present in a position indicated by i=1 and j=2 is output. In the example shown in FIG. 5, Y_{1, 2}=3 is output. As described above, an output value Y_{i, j} in each position is calculated while the position of the filter is being changed.

In other words, convolution layer Lc performs a computation in part (d) in FIG. 5 and corresponding to formula (2) below to output the output information, that is, the output value Y_{i, j}.

$$\begin{matrix}[ Math . 2 ] & \\ {Y}_{i , j} = {\sum }_{m}^{- 1 , 0 , 1} {\sum }_{n}^{- 1 , 0 , 1} {K}_{m , n} {X}_{i + m , j + n} & formula ( 2 )\end{matrix}$$

Hence, when p channels Ci are present, convolution layer Lc performs a computation corresponding to formula (3) below to output output information, that is, an output value Y_{i, j, co}. As described above, convolution layer Lc performs the three-dimensional processing on the input information represented in three dimensions of the i axis, the j axis, and the channel axis to output the output information.

$$\begin{matrix}[ Math . 3 ] & \\ {Y}_{i , j , C 0} = {\sum }_{Ci = 1}^{p} {\sum }_{m}^{- 1 , 0 , 1} {\sum }_{n}^{- 1 , 0 , 1} {K}_{m , n , Ci} {X}_{i + m , j + n , Ci} & formula ( 3 )\end{matrix}$$

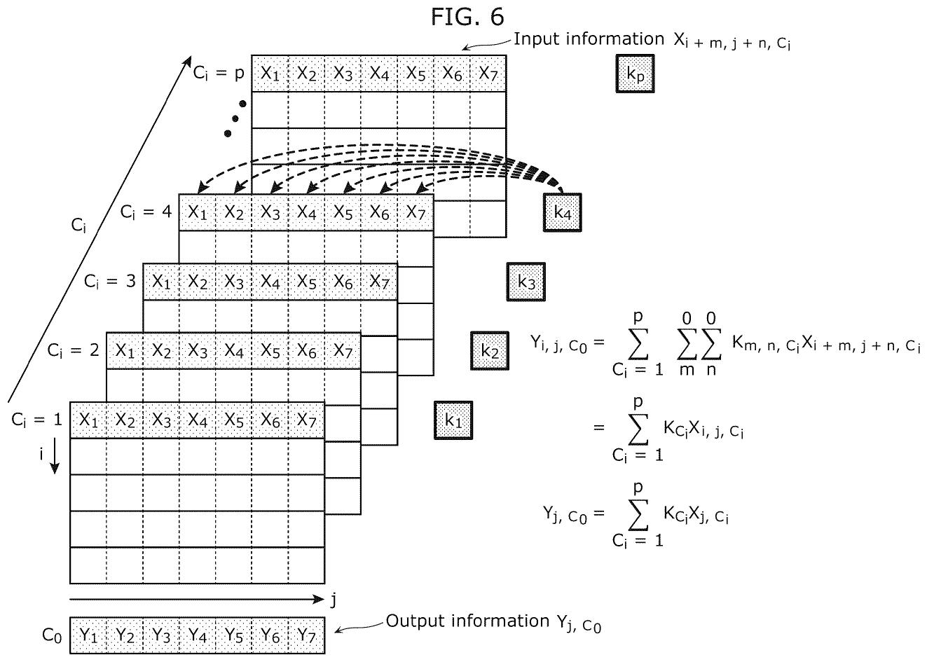

FIG. 6 is a diagram for illustrating the processing operation of convolution layer Lc when the size of the kernel is 1×1. The size of the kernel corresponds to the size of the filter shown in FIG. 5.

When the size of the kernel is 1×1, formula (3) is represented by formula (4) below.

$$\begin{matrix}[ Math . 4 ] & \\ {Y}_{i , j , C 0} = {\sum }_{Ci = 1}^{p} {\sum }_{m}^{0} {\sum }_{n}^{0} {K}_{m , n , Ci} {X}_{i + m , j + n , Ci} = {\sum }_{Ci = 1}^{p} {K}_{Ci} {X}_{i , j , Ci} & formula ( 4 )\end{matrix}$$

Furthermore, when the number of input values X disposed along the i axis is only one, that is, when i=1, in the processing operation of convolution layer Lc, as shown in FIG. 6, the dimension of the i axis can be omitted. Consequently, formula (4) is represented by formula (5) below.

$$\begin{matrix}[ Math . 5 ] & \\ {Y}_{j , C 0} = {\sum }_{Ci = 1}^{p} {K}_{Ci} {X}_{j , Ci} & formula ( 5 )\end{matrix}$$

The computation of convolution layer Lc represented by formula (5) as described above is equivalent to the computation of fully connected layer L3 represented by formula (1) described above.

Hence, transform unit 12 of information processing device 10 in the present embodiment can transform fully connected layer L3 included in first model m1 into convolution layer Lc equivalent to fully connected layer L3. Furthermore, transform unit 12 can delete dimensional transformation layer L2 and dimensional inverse transformation layer L4 which are inserted such that two-dimensional processing is performed by fully connected layer L3 in the three-dimensional processing performed by first model m1.

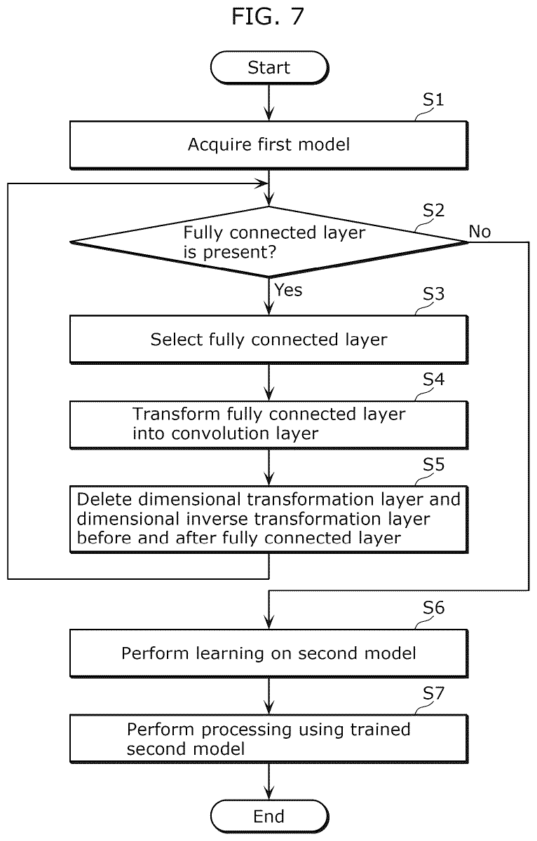

FIG. 7 is a flowchart showing an example of the processing operation of information processing device 10 in the present embodiment.

Input acquirer 11 of information processing device 10 first acquires first model m1 (step S1). Then, transform unit 12 determines whether fully connected layer L3 is included in acquired first model m1 (step S2). Here, when transform unit 12 determines that fully connected layer L3 is included (yes in step S2), transform unit 12 selects fully connected layer L3 described above (step S3) and transforms it into convolution layer Lc (step S4). Furthermore, transform unit 12 deletes dimensional transformation layer L2 and dimensional inverse transformation layer L4 before and after fully connected layer L3 (step S5).

After the processing in step S5, transform unit 12 repeatedly performs the processing from step S2 again. When in step S2, transform unit 12 determines that fully connected layer L3 is not included in first model m1 (no in step S2), trainer 14 performs processing in step S6. In step S6, trainer 14 performs machine learning on second model m2 generated by the processing in steps S2 to S5 to generate trained second model mk (step S6). Then, processor 15 performs processing using trained second model mk (step S7). In other words, processor 15 inputs processing target information to trained second model mk to acquire output information output from trained second model mk, and outputs the output information to the outside of information processing device 10.

For example, when first model m1 is the Transformer, the speed of the processing using trained second model mk, that is, the speed of the processing in step S7 is about 20% higher than the speed of processing using machine-trained first model m1. Although in the example shown in FIG. 7, all fully connected layers L3 included in first model m1 are replaced with convolution layers Lc, fully connected layer L3 may be left in second model m2. In other words, the processing in steps S2 to S5 may be performed on only a part of all fully connected layers L3 included in first model m1 to generate second model m2.

As described above, information processing device 10 in the present embodiment acquires first model m1 of deep learning, selects fully connected layer L3 included in first model m1, transforms fully connected layer L3 selected into convolution layer Lc, and deletes dimensional transformation layer L2 and dimensional inverse transformation layer L4 included in first model m1. Dimensional transformation layer L2 transforms the number of dimensions of the input information from three to two, and outputs the input information represented in two dimensions to fully connected layer 3. Dimensional inverse transformation layer L4 inversely transforms the number of dimensions of the output information output from fully connected layer L3 from two to three.

In this way, fully connected layer L3 which performs processing (that is, two-dimensional processing) on the input information represented in two dimensions is transformed into convolution layer Lc which performs processing (that is, three-dimensional processing) on the input information represented in three dimensions. Furthermore, dimensional transformation layer L2 and dimensional inverse transformation layer L4 necessary for the two-dimensional processing in fully connected layer L3 are deleted from first model m1. By the transformation into convolution layer Lc and the deletion of dimensional transformation layer L2 and dimensional inverse transformation layer L4 as described above, second model m2 equivalent to first model m1 can be generated. Then, the number of layers included in second model m2 is less than the number of layers included in first model m1, and thus the speed of the processing using second model m2 can be increased. Consequently, it is possible to generate a deep learning model capable of high-speed processing without deterioration of accuracy. The processing described above is also said to be inference. Hence, it is possible to generate a deep learning model capable of high-speed inference processing without deterioration of inference accuracy.

Specifically, the input information represented in three dimensions includes a plurality of input values arranged along a first axis, a second axis, and a channel axis. The input information represented in two dimensions includes a plurality of input values arranged along the second axis and the channel axis. Fully connected layer L3 includes, for each of channels Ci on the channel axis, a weighting coefficient K_{ci} to be applied to the input information represented in two dimensions.

Convolution layer Lc includes, for each of the channels Ci on the channel axis, a kernel to be applied to the input information represented in three dimensions. Here, the size of the kernel for each of the channels Ci is 1×1, and in the input information represented in three dimensions which is input to convolution layer Lc, the total number of input values disposed along the first axis is one. The first axis, the second axis, and the channel axis correspond to the i axis, the j axis, and the Ci axis described above, respectively.

In this way, it is possible to appropriately generate a deep learning model capable of high-speed processing without deterioration of accuracy.

In information processing device 10 in the present embodiment, the processor realizes the function of trainer 14. Specifically, the processor performs machine learning on second model m2 which is generated by transforming fully connected layer L3 into convolution layer Lc and deleting dimensional transformation layer L2 and dimensional inverse transformation layer L4.

In this way, it is possible to obtain an inference result corresponding to the machine learning. It is also possible to rapidly obtain an inference result equivalent to an inference result caused by machine-trained first model m1.

### Variation

Here, in the example described above, trainer 14 performs machine learning on second model m2. On the other hand, in the present variation, when already machine-trained first model m1 is present, machine learning is not performed, and a parameter included in trained first model m1 is copied to second model m2.

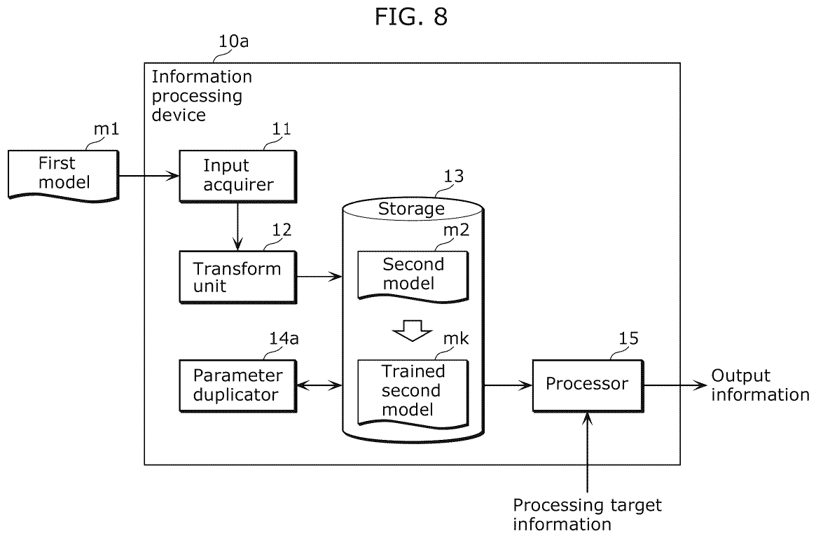

FIG. 8 is a block diagram showing an example of the configuration of an information processing device in the variation of the present embodiment.

Information processing device 10a in the present variation includes input acquirer 11, transform unit 12, storage 13, parameter duplicator 14a, and processor 15. In other words, information processing device 10a in the present variation has a configuration in which trainer 14 included in information processing device 10 shown in FIG. 1 is replaced with parameter duplicator 14a.

When parameter duplicator 14a acquires already machine-trained first model m1, parameter duplicator 14a duplicates a parameter included in first model m1, and inserts the duplicated parameter into second model m2. When first model m1 acquired by input acquirer 11 is already machine-trained first model m1, parameter duplicator 14a may duplicate a parameter included in first model m1. The duplicated parameter is a parameter which is set by machine learning performed on first model m1. Specifically, the parameter is a weighting coefficient which fully connected layer L3 included in machine-trained first model m1 has.

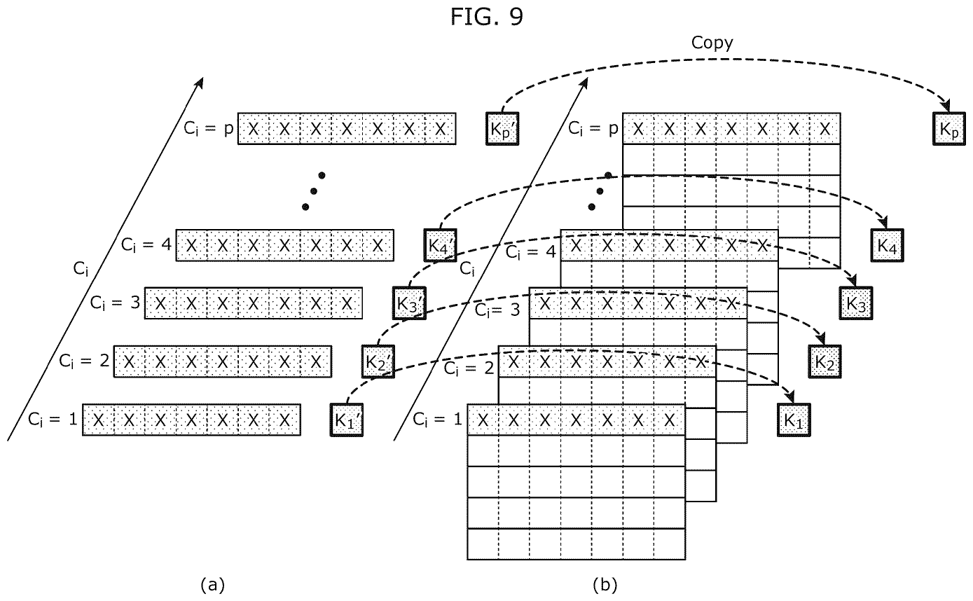

FIG. 9 is a diagram for illustrating the processing of parameter duplicator 14a in the variation of the present embodiment.

For example, as shown in part (a) in FIG. 9, after machine learning is performed on first model m1, as weighting coefficients corresponding to channels Ci in fully connected layer L3, values corresponding to the machine learning are set. For example, as weighting coefficients for channels Ci of 1 to p, values K₁′ to Kₚ′ are set, respectively.

When fully connected layer L3 is transformed by transform unit 12 into convolution layer Lc, parameter duplicator 14a copies the weighting coefficients K₁′ to Kₚ′ set by the machine learning of fully connected layer L3 to the kernel of convolution layer Lc. In other words, the weighting coefficients K₁′ to Kₚ′ for fully connected layer L3 are duplicated, and are inserted into second model m2 as filter coefficients K₁ to Kₚ which are the kernel of convolution layer Lc. In this way, convolution layer Lc described above can be used as convolution layer Lc included in trained second model mk. In other words, trained second model mk can be generated without machine learning being performed on second model m2.

As described above, in information processing device 10a of the present variation, the processor duplicates a parameter for first model m1 on which machine learning has already been performed, and inserts the duplicated parameter into second model m2 which is generated by transforming fully connected layer L3 into convolution layer Lc and deleting dimensional transformation layer L2 and dimensional inverse transformation layer L4.

In this way, trained second model mk can be generated without machine learning being performed on second model m2, and thus it is possible to increase the efficiency of generation of a model.

Although the information processing device of the present disclosure has been described above based on the above embodiment and the variation thereof, the present disclosure is not limited to the above embodiment and the variation. Embodiments obtained by performing various modifications conceived by a person skilled in the art on the above embodiment and the variation may also be included in the present disclosure without departing from the spirit of the present disclosure.

In the embodiment described above, constituent elements may be formed by dedicated hardware or may be realized by executing software programs suitable for the constituent elements. A program executor such as a CPU or a processor may read and execute software programs recorded in a recording medium such as a hard disk or a semiconductor memory such that the constituent elements are realized. Here, software for realizing information processing device 10 or 10a and the like in the embodiment is computer programs which cause a computer to execute the steps in the flowchart shown in FIG. 7.

The following cases are also included in the present disclosure.

(1) Specifically, at least one of the devices described above are a computer system which includes a microprocessor, a ROM, a RAM, a hard disk unit, a display unit, a keyboard, a mouse and the like. In the RAM or the hard disk unit, computer programs are stored. The microprocessor is operated according to the computer programs, and thus at least one of the devices described above achieve the functions thereof. Here, the computer programs are formed by combining a plurality of command codes for indicating instructions to the computer in order to achieve predetermined functions.

(2) A part or all of constituent elements of at least one of the devices described above may be formed with one system large scale integration (LSI) circuit. The system LSI circuit is an ultra-multifunctional LSI circuit manufactured by integrating a plurality of constituent units on one chip, and is specifically a computer system which includes a microprocessor, a ROM, a RAM, and the like. In the RAM, computer programs are stored. The microprocessor is operated according to the computer programs, and thus the system LSI circuit achieves the functions thereof.

(3) A part or all of constituent elements of at least one of the devices described above may be formed with an IC card or a single module which is removal with respect to the devices. The IC card or the module is a computer system which includes a microprocessor, a ROM, a RAM and the like. The IC card or the module may include the ultra-multifunctional LSI circuit. The microprocessor is operated according to computer programs, and thus the IC card or the module achieves the functions thereof. The IC card or the module may be tamper resistant.

(4) The present disclosure may be the methods described above. The present disclosure may be computer programs which realize these methods with a computer or may be digital signals of computer programs.

The present disclosure may be computer-readable recording media, such as a flexible disc, a hard disk, a compact disc (CD)-ROM, a DVD, a DVD-ROM, a DVD-RAM, a Blu-ray (registered trademark) disc (BD), and a semiconductor memory, in which computer programs or digital signals are recorded. The present disclosure may be digital signals recorded in these recording media.

The present disclosure may be a system in which computer programs or digital transmitted via signals are a telecommunication line, a wireless or wired communication line, a network such as the Internet, data broadcasting, or the like.

The programs or digital signals may be recorded in a recording medium and transferred or may be transferred via a network or the like such that another independent computer system uses the programs or digital signals.

### Further Information about Technical Background to this Application

The disclosure of the following patent application including specification, drawings, and claims are incorporated herein by reference in their entirety: Japanese Patent Application No. 2023-202225 filed on Nov. 29, 2023.

### Industrial Applicability

The information processing device of the present disclosure can be applied to, for example, a device, a system, or the like which handles a deep learning model.

1. An information processing device comprising:
a processor; and
a memory that is connected to the processor, wherein using the memory, the processor:
acquires a first model of deep learning;
selects a fully connected layer included in the first model;
transforms the fully connected layer selected into a convolution layer; and
deletes a dimensional transformation layer and a dimensional inverse transformation layer that are included in the first model,
the dimensional transformation layer:
transforms a total number of dimensions of input information from three to two; and
outputs the input information represented in two dimensions to the fully connected layer, and
the dimensional inverse transformation layer inversely transforms a total number of dimensions of output information output from the fully connected layer from two to three.

2. The information processing device according to claim 1, wherein
the processor further performs machine learning on a second model that is generated by:
transforming the fully connected layer into the convolution layer; and
deleting the dimensional transformation layer and the dimensional inverse transformation layer.

3. The information processing device according to claim 1, wherein
the processor further duplicates a parameter for the first model on which machine learning has already been performed, and inserts the parameter duplicated into a second model that is generated by:
transforming the fully connected layer into the convolution layer; and
deleting the dimensional transformation layer and the dimensional inverse transformation layer.

4. The information processing device according to claim 1, wherein
the input information represented in three dimensions includes a plurality of input values arranged along a first axis, a second axis, and a channel axis,
the input information represented in two dimensions includes a plurality of input values arranged along the second axis and the channel axis,
the fully connected layer includes, for each of channels on the channel axis, a weighting coefficient to be applied to the input information represented in two dimensions,
the convolution layer includes, for each of the channels on the channel axis, a kernel to be applied to the input information represented in three dimensions,
a size of the kernel for each of the channels is 1×1, and
in the input information represented in three dimensions that is input to the convolution layer, a total number of input values disposed along the first axis is one.

5. An information processing method performed by a computer, the information processing method comprising:
acquiring a first model of deep learning;
selecting a fully connected layer included in the first model;
transforming the fully connected layer selected into a convolution layer; and
deleting a dimensional transformation layer and a dimensional inverse transformation layer included in the first model, wherein
the dimensional transformation layer:
transforms a total number of dimensions of input information from three to two; and
outputs the input information represented in two dimensions to the fully connected layer, and
the dimensional inverse transformation layer inversely transforms a total number of dimensions of output information output from the fully connected layer from two to three.
